(19) United States
(12) Patent Application Publication
(10) Pub. No.: US 2007/0296326 A1
(43) Pub. Date: Dec. 27, 2007

(54) LIGHT-STORAGE SELF-LUMINESCENT GLASS AND THE PROCESS FOR PRODUCING THE SAME

(75) Inventors: Zhiguo Xiao, Dalian (CN); Jialing Dai, Dalian (CN); Xixian Luo, Dalian (CN); Jianxiong Liu, Dalian (CN); Wei Xia, Dalian (CN); Lifang Liu, Dalian (CN)

Correspondence Address: ROPES & GRAY LLP;PATENT DOCKETING 39/361, 1211 AVENUE OF THE AMERICAS, NEW YORK, NY, 10036-8704, US

(73) Assignee: DSLIAN LUMINGLIGHT SCIENCE AND TECHNOLOGY COMPANY, LTD

(21) Appl. No.: 11/851,031

(22) Filed: Sep. 6, 2007

Related U.S. Application Data
(62) Division of application No. 10/782,621, filed on Feb. 18, 2004.

(51) Int. Cl. H01J 63/04; C03B 9/00

(52) U.S. Cl. 313/483; 65/68; 65/79

(57) ABSTRACT

A light-storage self-luminescent glass is disclosed, comprising from 0.01 to 40% of a light-storage self-luminescent material activated by multiple ions and from 99.99 to 60% of a matrix glass; wherein the light-storage self-luminescent material has a particle size from 10 μm to 20 mm, and the matrix glass can be a low melting point glass or a common silicate glass. A process for producing the glass is also disclosed, comprising doping a light-storage self-luminescent material during the forming process of a common silicate glass, or thoroughly mixing low melting point glass powder with a light-storage self-luminescent material, and then heat treating the system at 700-1100° C. to obtain the light-storage self-luminescent glass. The process is simple and the cost is low.

The present invention relates to glass material, in particular light-storage self-luminescent glass and the process for producing the same.

In 1990's, two kinds of light-storage self-luminescent materials, i.e., aluminate system materials and silicate system materials, were developed in succession. These two kinds of light-storage self-luminescent materials are superior to the conventional sulfides light-storage self-luminescent materials in luminance, luminous time and chemical stability.

Glass plays a significant role in human's daily life, and the combination of glass with a luminescent material relates to a novel field.

CN1235935A put forward high-brightness luminescent glass and a process for producing the same, comprising mixing from 10 to 30% by weight of luminescent powder and from 70 to 90% by weight of glass powder to produce a mixture, and burning the resultant mixture under 650-900° C. to obtain the high-brightness luminescent glass. However, the following unavoidable defects are present in this application:

(1) The producing process is single, and the use scope is narrow.

(2) Alkaline earth aluminate luminescent material is exclusively used as the luminescent powder, thus the material is single.

CN1305967A provided a process for producing rare-earth yellow-green long-afterglow luminescent glass, comprising adding a flux and a rare earth as a doping agent to a glass matrix consisting of strontium oxide, aluminum oxide and boron oxide to produce a mixture, homogenizing the mixture by grinding, and isothermally treating the mixture to obtain the product. However, this process is only limited to producing aluminate glass.

CN1317456A disclosed a process for producing red, green and yellow long-afterglow manganese-doped boron-silicon-zinc luminescent glass, comprising individually- or co-doping manganese and samarium ions to a glass matrix consisting of silica, boron oxide, and any one of zinc carbonate and zinc oxide to produce a mixture, homogenizing the mixture by grinding, and isothermally treating the mixture to obtain the product. But said process is only limited to producing boron-silicon-zinc system glass.

U.S. Pat. No. 197,712 related to a process for producing luminescent glass, comprising mechanically mixing an inorganic luminescent material with Na—Ca—Si system glass, and forming long-afterglow luminescent glass by using a preparation process for common glass. However, the matrix for the inorganic luminescent material is CaS, SrS and BaS, and the afterglow time is short.

U.S. Pat. No. 6,123,872, U.S. Pat. No. 6,271,160 and U.S. Pat. No. 4,946,622 related to long-afterglow oxide glass, which, however, can be excited by gamma ray, X ray and UV ray rather than by visible light. Moreover, the afterglow time is short, and the brightness is low.

Considering the shortcomings of the prior art, the present invention provides light-storage self-luminescent glass which has diversified luminescent colors and a long afterglow time and can be produced from various kinds of luminescent powders simply, and the process for producing the same.

The object of the invention is to provide light-storage self-luminescent glass and the process for producing the same. The glass according to this invention can emit light for 10 mins to 20 hrs after being illuminated under sunshine or lamplight for 10 mins. The glass can be repetitively used, and is of non-toxicity and non-radioactivity. Moreover, the production process is simple, and a glass plant can produce said light-storage self-luminescent glass without needing additional apparatus.

The light-storage self-luminescent glass in the present invention comprises a light-storage self-luminescent material activated by multiple ions and a matrix glass; particularly, comprises from 0.01 to 40% by weight of a light-storage self-luminescent material, and from 99.99 to 60% by weight of a matrix glass; wherein the particle size of said light-storage self-luminescent material is from 10 μm to 20 mm and the matrix glass is low melting point glass or conventional silicate glass.

The light-storage self-luminescent material used in the invention is silicate, aluminate, sulfide or mixtures thereof, activated by multiple ions, and the main chemical formulae and the luminous afterglow colors of the light-storage self-luminescent materials are as follows:

1. The chemical formula of a silicate light-storage self-luminescent material activated by multiple ions is as follows:
αMO.βM′O.γSiO₂.δR:EuₓLn_{y}

wherein M is one or more selected from the group consisting of Sr, Ca, Ba and Zn;

M′ is one or more selected from the group consisting of Mg, Cd and Be;

R is B₂O₃, P₂O₅ or mixture thereof;

Ln is one or more selected from the group consisting of Nd, Dy, Ho, Tm, La, Pr, Th, Ce, Er, Mn, Bi, Sn and Sb; and

α, β, γ, δ, x and y are molar coefficients meeting following requirement:
0.6≦α≦6; 0≦β≦5; 1≦γ≦9; 0≦δ≦0.7; 0.00001≦x≦0.2; 0≦y ≦0.3.

Further experiments show that the following two kinds of light-storage self-luminescent materials among said silicate light-storage self-luminescent materials are preferably used to produce light-storage self-luminescent glass having relatively high brightness, mainly represented by following chemical formulae:
(Sr_{1-z}Ca_{z})₂MgSi₂O₇:EuₓLn_{y} 1-1.
(Sr_{1-z}Ca_{z})₃MgSi₂O₈:EuₓLn_{y} 1-2.

wherein Ln is one or more selected from the group consisting of La, Ce, Dy, Tm, Ho, Nd, Er, Sb and Bi;

Z is a coefficient meeting following requirement: 0≦z ≦1;

x and y are molar coefficients meeting following requirement: 0.0001≦x≦0.2; 0.0001≦y≦0.3.

Said preferred two kinds of silicate light-storage self-luminescent materials can respectively emit blue, blue-green, green, yellow-green and yellow light depending on z value. For example, when z=0, said materials emit blue light and when z=0.5, green light is emitted.

2. The chemical formula of an aluminate light-storage self-luminescent material activated by multiple ions is as follows:
αMO.βAl₂O₃.γB₂O: EuₓLn_{y}

wherein M is one or more selected from the group consisting of Mg, Ca, Sr and Zn;

Ln is one or more selected from the group consisting of Nd, Dy, Ho, Tm, La, Ce, Er, Pr and Bi; and

α, β, γ, x and y are molar coefficients meeting following requirement:
0.5 ≦α≦6; 0.5≦β≦9; 0≦γ≦0.3; 0.00001≦x≦0.15; 0.00001≦y≦0.2.

Further experiments show that, the following two kinds of light-storage self-luminescent materials among the above-mentioned aluminate light-storage self-luminescent materials are preferably used to produce light-storage self-luminescent glass having relatively high brightness, represented by following chemical formulae:
MAl₂O₄:EuₓLn_{y} 2-1.

wherein Ln is one or more selected from the group consisting of La, Ce, Dy, Ho, Nd and Er;

M is one or more selected from the group consisting of Sr, Ca, Mg and Zn; and

x and y are molar coefficients meeting following requirement: 0.0001≦x≦0.15;0.0001≦y≦0.2.

The material according to the formula 2-1 can emit various colors of lights depending on M value. For instance, when M=Sr, said material emits yellow-green light and when M=Ca, blue-purple light is emitted.
M₄Al₁₄O₂₅:EuₓLn_{y} 2-2.

wherein Ln is one or more selected from the group consisting of Pr, Ce, Dy, Ho, Nd and Er;

M is one or more selected from the group consisting of Sr, Ca, Mg and Zn; and

x and y are molar coefficients meeting following requirement: 0.0001≦x≦0.15; 0.0001≦y≦0.2.

3. The chemical formulae of a sulfide light-storage self-luminescent material activated by multiple ions are as follows:
(Ca_{1-z}Sr_{z})S:EuₓLn_{y} 3-1.

wherein Ln is one or more selected from the group consisting of Er, Dy, La, Tm and Y;

z is a coefficient, 0≦z≦1; and

x and y are molar coefficients meeting following requirement: 0.00001≦x≦0.2;0.00001≦y≦0.15.

Said material can emit red and orange light depending on z value.
R₂O₂S:EuₓLn_{y} 3-2.

wherein R is one or more selected from the group consisting of Y, La and Gd;

Ln is one or more selected from the group consisting of Er, Cr, Bi, Dy, Tm, Ti, Mg, Sr, Ca, Ba and Mn; and

x and y are molar coefficients meeting following requirement: 0.00001≦x≦0.2; 0.00001y≦0.6.

The light-storage self-luminescent material used in the present invention can be one or more selected from the aforementioned light-storage self-luminescent materials, which can self-emit the light of bright red, orange-red, hermosa pink, yellow, green, blue, purple, white or a semi-color.

The matrix glass used in the present invention can be low melting point glass or conventional silicate glass.

(1) The composition of the low melting point glass is as follows (by weight percent):

| | |
|---|---|
| SiO₂: 10-45% | MgO: 0-8% |
| Al₂O₃: 1-5% | CaO: 2-10% |
| B₂O₃: 0-50% | SrO: 1-10% |
| Li₂O: 0-6% | BaO: 0-7% |
| Na₂O: 5-20% | ZnO: 0-10% |
| K2O: 0-20% | ZrO₂: 0-1% |
| TiO₂: 0-20%. | |

(2) The composition of the conventional silicate glass is as follows (by weight):

| | |
|---|---|
| SiO₂: 30-81% | CaO: 0.5-9% |
| Al₂O₃: 0-23% | MgO: 1-8% |
| B₂O₃: 0-15% | SrO: 1-10% |
| Li₂O: 0-8% | BaO: 0-16% |
| Na₂O: 0.6-18% | ZnO: 0.6-55% |
| K₂O: 0.4-16% | PbO: 0-33% |
| As₂O₃: 0-0.5%. | |

Using other conventional glasses such as borate glass, phosphate glass, halide glass, sulfide glass and common sodium-calcium-silicon glass or slag glass that is currently widely used in glass industry, satisfactory light-storage self-luminescent glass can be produced according to the present invention.

The light-storage self-luminescent glass according to the present invention can be produced via four processes as follows:

(1) According to the formulation of conventional silicate glass or common sodium-calcium-silicon glass that is widely used in glass industry, after the fusion of the glass is completed, a light-storage self-luminescent material is doped into the glass and the resultant is formed at 900-1300° C. to produce light-storage self-luminescent glass, wherein the production temperature of the light-storage self-luminescent glass is not limited, and the light-storage self-luminescent material used may be one or more selected from the aforementioned light-storage self-luminescent materials.

(2) A conventional silicate glass rod or tube is heated and melted by a glass blower, a light-storage self-luminescent material is doped therein, and the resultant glass is secondarily formed, wherein the light-storage self-luminescent material used may be one or more selected from the aforementioned light-storage self-luminescent materials.

(3) According to the formulation of the above-mentioned low melting point glass, the low melting point glass is melted, cooled down, and crushed till a certain fineness to obtain glass powder. The resultant glass powder is thoroughly mixed with a light-storage self-luminescent material to obtain a mixture. The obtained mixture is heat treated at 700-1100° C. to obtain light-storage self-luminescent glass, wherein the light-storage self-luminescent material used may be one or more selected from the aforementioned light-storage self-luminescent materials 1 or 3.

(4) According to the formulation of conventional silicate glass or low melting point glass, after the fusion of the glass is completed, a light-storage self-luminescent material is doped into the glass metal contained in a crucible with stirring to obtain a mixture. Then the mixture is secondarily clarified before forming, wherein the light-storage self-luminescent material used may be one or more selected from the aforementioned light-storage self-luminescent materials 1 or 3.

As regard to the above-mentioned four production processes, the forming step may be machine making, moulding, pressing or hand forming; and the formed and deeply-processed light-storage self-luminescent glass article may be in any physical shape.

The illustrative light-storage self-luminescent materials according to the present invention are listed as follows:

| Serial | Light-storage | Luminescence | Emission |
|---|---|---|---|
| No. | self-luminescent material | color | wavelength (nm) |
| 1 | CaAl₂O₄:Eu_{0.05}Nd_{0.05} | Purple | 440 |
| 2 | Sr₂MgSi₂O₇:Eu_{0.05}Dy_{0.05} | Blue | 470 |
| 3 | Sr₄Al₁₄O₂₅:Eu_{0.05}Dy_{0.05} | Blue-green | 490 |
| 4 | SrAl₂O₄:Eu_{0.05}Dy_{0.05} | Yellow-green | 520 |
| 5 | Y₂O₂S:Eu_{0.02}Ti_{0.02}Tm_{0.04} | Orange-red | 600 |
| 6 | SrS:Eu_{0.001}Cl | Red | 620 |

The examples in the present invention are illustrated in detail as follows.

### EXAMPLE 1

10 g of yellow light-storage self-luminescent material 4 (SrAl₂O₄:Eu_{0.05}Dy_{0.05}) having a particle size of 1.2 mm was doped into 3.8 kg of sodium-calcium-aluminum-silicon glass metal as a matrix comprising (wt %) 72.5% of SiO₂, 1.5% of Al₂O₃, 2.0% of B₂O₃, 7.0% of CaO, 1.0% of MgO, 15.0% of Na₂O, 0.5% of BaO and 0.3% of K₂O at 1250° C. to produce a mixture. The mixture is stirred on a steel platform and then passed to a calender where the mixture is pressed into a decorative glass slab (800×600×3 mm).

The obtained glass slab is made into lamps, which can self-emit yellow-green light for above 10 hrs after power-off.

The above process can also be applied to the light-storage self-luminescent materials 1, 2, 3 and 5 having a particle size of from 20 μm to 1.5 mm.

### EXAMPLE 2

Starting Materials:

2 g of white light-storage self-luminescent material 2 (Sr₂MgSi₂O₇:Eu_{0.05}Dy_{0.05}) having a particle size of 0.8 mm; and

0.5 kg of sodium-calcium-silicon glass metal as a matrix,.

The composition of said glass metal is as follows (%):

| | component | | | | | | |
|---|---|---|---|---|---|---|---|
| | SiO₂ | B₂O₃ | CaO | ZnO | Na₂O | BaO | K₂O |
| Amount, wt % | 75.3 | 0.5 | 5.5 | 1.0 | 15.0 | 1.0 | 1.5 |

The matrix glass is firstly blown into a parison bubble, and then the resultant bubble is dipped with the light-storage self-luminescent material (at 1200° C.), flashed, and moulded to produce a light-storage self-luminescent glass vase.

The obtained vase per se can emit a very soft blue light in the dark for above 10 hrs after being illuminated under sunshine or lamplight for 10 min.

The above process can also be used to blow luminous glass crafts in various shapes such as vases, fruit trays, ashtrays, and candlesticks.

The above process can also be applied to the light-storage self-luminescent materials 1, 3, 4 and 5 (at a particle size of from 20 μm to 1.5 mm).

### EXAMPLE 3

Starting Materials:

2 g of white light-storage self-luminescent material 5 (Y₂O₂S:Eu_{0.02}Ti_{0.02}Tm_{0.04}) having a particle size of from 12 to 60 μm; and 0.5 kg of medium lead glass metal as a matrix.

The composition of said glass metal is as follows:

| Component | SiO₂ | PbO | Na₂O | K₂O |
|---|---|---|---|---|
| Amount, wt % | 58.2 | 25.3 | 2.4 | 14 |

The matrix glass is firstly blown into a parison bubble, and the light-storage self-luminescent material is added inside the resultant bubble (at 1150° C.) from the mouth of the blowing iron. The resultant system is flashed and formed, the top mouth thereof is sealed under the forming temperature of the glass, and then a luminous mountain crystal glass apple is obtained after shaping.

The obtained luminous glass apple exhibits the effect of a white ceramic glass at daytime or under lamplight, and can per se emit orange-red light in the dark for 4 hrs after being illuminated under sunshine or lamplight for 10 min.

The above process can be used in the production of hollow sealed light-storage self-luminescent glass articles in various shapes such as light-storage self-luminescent glass fruits, animals and the like.

The above process can also be applied to the light-storage self-luminescent materials 1, 2, 3, 4 and 6 (at a particle size of from 20 μm to 1.5 mm).

### EXAMPLE 4

A transparent glass metal (as described in Example 1) is stuck onto two blowing irons respectively. The blowing irons are further roll-dipped with different light-storage self-luminescent materials (light-storage self-luminescent material 3 having a particle size of 0.55 mm, 3 g and light-storage self-luminescent material 4 having a particle size of 0.55 mm, 3 g), and then the blowing irons are respectively flashed and hand formed into two individual glass gooses. The two glass gooses are fixed on a glass baseplate, and then annealed to form a pair of light-storage self-luminescent glass gooses.

After being illuminated under visible light for 10 min, the obtained luminous glass gooses can respectively self-emit yellow-green light and blue-green light in the dark for above 10 hrs.

The above process and the light-storage self-luminescent materials 1 and 2 having a particle size of from 0.3 mm to 2 mm can be applied to various glass animals, candlesticks, vases, saucedishes, napkin racks, glass flowers and glass lampshades.

### EXAMPLE 5

A matrix glass metal (as described in Example 2) is charged into a φ70×20 die. The light-storage self-luminescent material 4 having a particle size of from 0.3 to 0.4 mm is spreaded onto the surface of the glass metal. Then the surface is covered with additional glass metal. The resultant system is pressed into a φ70×20 light-storage self-luminescent glass floor brick. The obtained glass floor brick can self-emit light for above 10 hrs after being illuminated under visible light for 10 min.

The above process can also be used in the production of various pressed glass articles in circular, rectangular and elliptical shapes.

The above process can also be applied to long-afterglow materials 1, 2, 3 and 5.

### EXAMPLE 6

Starting materials: light-storage self-luminescent material 3 (Sr₄Al₁₄O₂₅:Eu_{0.05}Dy_{0.05}) having a particle size of from 12 to 18 μm, 2.4 g; a glass metal as described in Example 2, 0.8 kg; and four sodium-calcium-silicon glass tubes, θ4×1×8 mm.

Preliminary preparations: after one end of the glass tube is sealed, the four glass tubes are individually filled with the light-storage self-luminescent material, and then the other end of each of the tubes is sealed. The four sealed glass tubes are evenly placed into a wiring die.

A matrix glass parison bubble is stuck with the glass tube filled with the light-storage self-luminescent material in the wiring die, and then flashed and formed to obtain a bar light-storage self-luminescent glass wine bowl.

After being illuminated under sunshine or lamplight for 10 min, the obtained bar light-storage self-luminescent glass wine bowl can self-emit blue-green light in the dark for over 10 hrs.

The above process can also be applied to long afterglow materials 1, 2, 4 and 5.

The above process can also be used in the production of wired light-storage self-luminescent glass articles in various shapes.

### EXAMPLE 7

Starting materials: light-storage self-luminescent material 2 (Sr₂MgSi₂O₇:Eu_{0.05}Dy_{0.05}) having a particle size of 0.8 μm, 2 g; and two silicate glass rods, φ4×200 mm.

One end of one glass rod and the end of the other glass rod which is opposite to the former glass rod are heated and melted on a blow lamp flame by a glass blower. The light-storage self-luminescent material is dipped onto the glass rods with stirring well. Then the system is hand formed into a glass ball after the light-storage self-luminescent material has completely entered into the matrix glass.

After being illuminated under sunshine or lamplight for 10 min, the obtained glass ball can self-emit blue light in the dark for over 10 hrs.

The above process can also be applied to long afterglow materials 1, 3 and 4.

The above secondary forming process by a glass blower can also be used in the production of all types of small light-storage self-luminescent articles such as glass animals, plants and necklaces.

### EXAMPLE 8

Starting materials: light-storage self-luminescent material 3 (Sr₄Al₁₄O₂₅:Eu_{0.05}Dy_{0.05}) having a particle size of 60 μm, 0.5 kg; and a matrix metal comprising (wt %):

| | |
|---|---|
| SiO₂: 29% | Al₂O₃: 1% |
| B₂O₃: 33% | Li₂O: 5% |
| NaO: 9% | TiO₂: 2% |
| CaO: 5% | SrO: 10% |
| PbO 6% | |

The matrix glass is melted, clarified and homogenized in a crucible, into which the light-storage self-luminescent material is added. Then the system is mixed well using a 1Cd₁₈Ni9Ti rod, secondarily clarified, and pressed into an integrally luminous glass ashtray.

After being illuminated under sunshine or lamplight for 10 min, the obtained ashtray can self-emit blue-green light in the dark for over 8 hrs.

The above process can also be applied to the light-storage self-luminescent materials 1, 2 and 4 having a particle size of from 30 to 80 μm for press forming light-storage self-luminescent glass articles in various shapes.

### EXAMPLE 9

Starting materials: low melting point glass comprising (wt %):

| | |
|---|---|
| SiO₂: 29% | Al₂O₃: 1% |
| B₂O₃: 33% | Li₂O: 5% |
| Na₂O: 9% | TiO₂: 17% |
| CaO: 5% | SrO: 1%; |

Light-storage self-luminescent material 2 (Sr₂MgSi₂O₇:Eu_{0.05}Dy_{0.05}) having a particle size of from 30 to 50 μm.

The low melting point glass is melted, cooled down and crushed to obtain 250-mesh glass powder. 80 g of the glass powder is mixed well with 20 g of the light-storage self-luminescent material and then the resultant mixture is melted at 850-900° C. for 1.5 h in an air atmosphere in a furnace, moulded and annealed to obtain light-storage self-luminescent glass.

After being illuminated under sunshine or lamplight for 10 min, the obtained light-storage self-luminescent glass can self-emit blue light in the dark for over 10 hrs.

The above process can also be applied to the light-storage self-luminescent glass material 5.

The light-storage self-luminescent glass obtained in the above process can be subject to deep processing such as knifing, cutting, drilling, polishing and grinding.

1-15. (canceled)

16. An article of light-storage self-luminescent glass, comprising:
from 0.01% to 40% by weight of a light-storage self-luminescent material activated by multiple ions; and
from 99.99% to 60% by weight of a matrix glass, wherein, during a forming process of the article of self-luminescent glass, the-matrix glass is melted and the self-luminescent material is doped into the melted matrix glass to form the article;
wherein the article of self-luminescent glass is selected from the group consisting of a hollow glass article, a laminated glass article, and a stripped-luminescent glass article;
wherein a luminescent color of the article of self-luminescent glass is selected from the group consisting of red, orange-red, yellow-green, blue-green, blue and purple; and
wherein the light-storage self-luminescent material has a particle size from 10 μm to 20 mm.

17. An article of light-storage self-luminescent glass according to claim 16, wherein:
the article of self-luminescent glass is the hollow glass article, wherein the hollow glass article is sealed and has a pre-defined shape; and
the light-storage self-luminescent material is uniformly attached to an inner wall of the sealed hollow glass article.

18. An article of light-storage self-luminescent glass according to claim 16, wherein:
the article of self-luminescent glass is the laminated glass article, wherein the laminated glass article comprises top, middle and bottom layers, wherein the matrix glass is positioned along the top and bottom layers, wherein the laminated glass article has a pre-defined shape; and
the light-storage self-luminescent material is positioned within the middle layer between the top and bottom layers.

19. An article of light-storage self-luminescent glass according to claim 16, wherein:
the article of self-luminescent glass is the stripped-luminescent glass article, wherein the stripped-luminescent glass article has a pre-defined shape; and
the light-storage self-luminescent material is uniformly distributed as strips in a glass wall of the stripped-luminescent glass article.

20. A process for producing the article of light-storage self-luminescent glass according to claim 16, comprising:
preparing the melted matrix glass by formulating, mixing, melting, homogenizing and clarifying the matrix glass, wherein the melted matrix glass is brought to a temperature of 900-1300° C.; and
doping the light-storage self-luminescent material into the melted matrix glass to produce a mixture.

21. A process for producing the article of light-storage self-luminescent glass, wherein the self-luminescent glass is the hollow glass article, according to claim 20, further comprising:
blowing the melted matrix glass into a parison bubble using a blowing iron;
adding the light-storage self-luminescent material into the bubble from a mouth of the blowing iron such that the light-storage self-luminescent material is uniformly attached to the inner wall of the hollow glass article;
flashing, forming and sealing the bubble; and
shaping the article of light-storage self-luminescent glass.

22. A process for producing the article of light-storage self-luminescent glass, wherein the self-luminescent glass is the laminated glass article, according to claim 20, further comprising:
charging the melted matrix glass into a die, the charged melted matrix glass comprising a top surface;
spreading the light-storage self-luminescent material onto the top surface of the glass melt;
covering the charged melted matrix glass with an additional layer of melted matrix glass; and
pressing the covered charged melted matrix glass to form a pre-defined shape.

23. A process for producing the article of light-storage self-luminescent glass, wherein the self-luminescent glass is the stripped-luminescence glass article, according to claim 20, further comprising:
preparing a glass tube, the glass tube having first and second ends;
sealing the first end of the glass tube;
filling the glass tube with the light-storage self-luminescent material;
sealing the second end of the glass tube;
placing the glass tube with both ends sealed onto a wiring die;
blowing the melted matrix glass into a parison bubble;
sticking the matrix glass parison bubble with the glass tuble filled with the light-storage self-luminescent material on the wiring die; and
flashing the matrix glass parison bubble and the glass tube and blowing to form a pre-defined shape.

24. The article of light-storage self-luminescent glass according claim 16, wherein said light-storage self luminescent material activated by multiple ions is selected from the group consisting of silicate, aluminate, sulfide, and any combination thereof and the matrix glass is selected from the group consisting of silicate glass, borate glass, phosphate glass, halide glass, sulfide glass and aluminate glass.
